(19) United States
(12) Patent Application Publication
(10) Pub. No.: US 2004/0006652 A1
(43) Pub. Date: Jan. 8, 2004

(54) System event filtering and notification for OPC clients

(76) Inventors: John M. Prall, Cave Creek, AZ (US); Haur J. Lin, Phoenix, AZ (US); Jason T. Urso, Cave Creek, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/455,482

(22) Filed: Jun. 5, 2003

Related U.S. Application Data
(60) Provisional application No. 60/392,496, filed on Jun. 28, 2002.
(60) Provisional application No. 60/436,695, filed on Dec. 27, 2002.

(51) Int. Cl. G06F 9/46

(52) U.S. Cl. 709/318

(57) ABSTRACT

A system operating in a Windows environment that provides notification of events to OPC clients is disclosed. NT events generated in the system are filtered and converted to an OPC format for presentation to the OPC clients. The converted NT event notification includes a designation of the source that generated the NT event. The system includes a filter configuration tool that permits entry of user-defined filter criteria and transformation information. The transformation information includes the source designation, event severity, event type (simple, tracking and conditional), event category, event condition, event sub-condition and event attributes.

This Application claims the benefit of U.S. Provisional Application No. 60/392,496 filed Jun. 28, 2002, and U.S. Provisional Application No. 60/436,695 filed Dec. 27, 2002, the entire contents of which are incorporated by reference.

### FIELD OF THE INVENTION

This invention generally relates to filtration and notification of system events among a plurality of computing nodes connected in a network and, more particularly, to methods and devices for accomplishing the filtration and notification in a Windows Management Instrumentation (WMI) environment.

### BACKGROUND OF THE INVENTION

Web-Based Enterprise Management (WBEM) is an initiative undertaken by the Distributed Management Task Force (DMTF) to provide enterprise system managers with a standard, low-cost solution for their management needs. The WBEM initiative encompasses a multitude of tasks, ranging from simple workstation configuration to full-scale enterprise management across multiple platforms. Central to the initiative is a Common Information Model (CIM), which is an extendible data model for representing objects that exist in typical management environments.

WMI is an implementation of the WBEM initiative for Microsoft® Windows® platforms. By extending the CIM to represent objects that exist in WMI environments and by implementing a management infrastructure to support both the Managed Object Format (MOF) language and a common programming interface, WMI enables diverse applications to transparently manage a variety of enterprise components.

The WMI infrastructure includes the following components:

The actual WMI software (Winmgmt.exe), a component that provides applications with uniform access to management data.

The Common Information Model (CIM) repository, a central storage area for management data.

The CIM Repository is extended through definition of new object classes and may be populated with statically-defined class instances or through a dynamic instance provider.

OLE for Process Control™ (OPC™) is an emerging software standard designed to provide business applications with easy and common access to industrial plant floor data. Traditionally, each software or application developer was required to write a custom interface, or server/driver, to exchange data with hardware field devices. OPC eliminates this requirement by defining a common, high-performance interface that permits this work to be done once and then easily reused by Human Machine Interface (HMI), Supervisory Control and Data Acquisition SCADA, Control and custom applications.

The OPC specification, as maintained by the OPC Foundation, is a non-proprietary technical specification and defines a set of standard interfaces based upon Microsoft's OLE/COM technology. Component Object Model (COM) enables the definition of standard objects, methods, and properties for servers of real-time information such as distributed control systems, programmable logic controllers, input/output (I/O) systems, and smart field devices. Additionally, with the use of Microsoft's OLE Automation technology, OPC can provide office applications with plant floor data via local-area networks, remote sites or the Internet.

OPC provides benefits to both end users and hardware/software manufacturers, including:

Open connectivity: Users will be able to choose from a wider variety of plant floor devices and client software, allowing better utilization of best-in-breed applications.

High performance: By using latest technologies, such as “free threading”, OPC provides extremely high performance characteristics.

Improved vendor productivity: Because OPC is an open standard, software and hardware manufacturers will be able to devote less time to connectivity issues and more time to application issues, eliminating a significant amount of duplication in effort.

OPC fosters greater interoperability among automation and control applications, field devices, and business and office applications.

In a PC-based process control environment, not only the process-related events are important, but also some Windows system events play critical roles in control strategies and/or diagnostics. For example, an event that indicates the CPU or memory usage has reached a certain threshold requires users to take action before the system performance starts to degrade. However, the Windows system events do not conform to OPC standards and are not available to OPC clients. The present invention provides a mechanism to solve this problem.

The present invention also provides many additional advantages, which shall become apparent as described below.

### SUMMARY OF THE INVENTION

The method of the present invention concerns notification of OPC alarms and events (OPC-AEs) and NT alarms and events (NT-AEs) to an OPC client. The method converts an NT-AE notification of an NT-AE to an OPC-AE notification and presents the OPC-AE notification to the OPC client.

The OPC client, for example, is either local or remote with respect to a source that created the NT-AE. The OPC-AE notification is preferably presented to the OPC client via a multicast link or a WMI service.

In one embodiment of the method of the present invention, the OPC-AE notifications are synchronized among a plurality of nodes via the multicast link.

In another embodiment of the method of the present invention, the NT-AEs are filtered according to filter criteria, which are preferably provided by a filter configuration tool or a system event filter snap-in.

In still another embodiment of the method of the present invention, the converting step adds additional information to the NT-AE notification to produce the OPC-AE notification.

In one style of the embodiments of the method of the present invention, the additional information includes a designation of a source that created the NT-AE notification, which preferably comprises a name of a computer that created the NT-AE notification and an insertion string of the NT-AE. The insertion string, for example, identifies a component that generated the NT-AE.

In another style of the embodiments of the method, the additional information includes an event severity that is an NT-compliant severity. The converting step provides a transformation of the NT-compliant severity to an OPC-compliant severity. Preferably, the transformation is based on pre-defined severity values or on logged severity values of the NT-AE.

In still another style of the embodiments of the method, the additional information comprises one or more items selected from the group consisting of: event cookie, source designation, event severity, event category, event type, event acknowledgeability and event acknowledge state.

In the aforementioned embodiments of the method of the present invention, the NT-AEs comprise condition events, simple events or tracking events. The condition events, for example, reflect a state of a specific source.

The device of the present invention comprises a system event provider that links an NT-AE notification of an NT-AE to additional information and a system event server that packages the NT-AE notification and the additional information as an OPC-AE notification for presentation to the OPC client.

The OPC client, for example, is either local or remote with respect to a source that created the NT-AE notification. The OPC-AE notification is preferably presented to the OPC client via a multicast link or a WMI service.

In one embodiment of the device of the present invention, the OPC-AE notifications are synchronized among a plurality of nodes via the multicast link.

In another embodiment of the device of the present invention, the NT-AE notifications are filtered according to filter criteria, which are preferably provided by a filter configuration tool or a system event filter snap-in.

In still another embodiment of the device of the present invention, the system event provider adds additional information to the NT-AE notification to produce the OPC-AE notification.

In one style of the embodiments of the device of the present invention, the additional information includes a designation of a source that created the NT-AE notification, which preferably comprises a name of a computer that created the NT-AE notification and an insertion string of the NT-AE. The insertion string, for example, identifies a component that generated the NT-AE.

In another style of the embodiments of the device of the present invention, the additional information includes an event severity that is an NT-compliant severity. The system event provider provides a transformation of the NT-compliant severity to an OPC-compliant severity. Preferably, the transformation is based on pre-defined severity values or on logged severity values of the NT-AE.

In still another style of the embodiments of the device of the present invention, the additional information comprises one or more items selected from the group consisting of: event cookie, source designation, event severity, event category, event type, event acknowledgeability and event acknowledge state.

In the aforementioned embodiments of the device of the present invention, the NT-AEs comprise condition events, simple events or tracking events. The condition events, for example, reflect a state of a specific source.

In yet another embodiment of the device of the present invention, an NT event provider provides the NT-AEs; and a filter filters the NT-AE notifications according to filter criteria so that only NT-AE notifications that satisfy the filter criteria are linked to OPC-AEs by the system event provider. In one style of this embodiment, one or more of the NT-AEs are condition events that are generated by a source and that reflect a state of the source. The system event provider changes a status between active and inactive of an earlier-occurring one of the condition events in response to a later-occurring one of the condition events generated due to a change in state of the source. The system event provider further links the NT-AE notifications of the earlier- and later-occurring condition events to OPC-AE notifications for presentation to OPC clients.

In yet another embodiment of the method of the present invention, one or more of the NT-AEs are condition events that are generated by a source and that reflect a state of the source. The method additionally changes a status between active and inactive of an earlier-occurring one of the condition events in response to a later-occurring one of the condition events generated due to a change in state of the source. Preferably, the converting and presenting steps convert NT-AE notifications of the earlier- and later-occurring condition events to OPC-AE notifications for presentation to OPC clients.

An additional method of the present invention populates a filter that filters NT-AE notifications for conversion to OPC-AE notifications. This method enters NT-AEs for which notifications thereof are to be passed by the filter and configures the entered NT-AEs with one or more event characteristics selected from the group consisting of: event type, event source, event severity, event category, event condition, event sub-condition and event attributes.

According to one style of the additional method of the present invention, the event type comprises condition, simple and tracking.

According to another style of the additional method of the present invention, the event source comprises a name of a computer that created a particular NT-AE and an insertion string of the particular NT-AE.

According to still another style of the additional method of the present invention, the event severity comprises predefined severity values or logged severity values.

According to yet another style of the additional method of the present invention, the event category comprises a status of a device.

According to a further style of the additional method of the present invention, the event attributes comprise for a particular event category an acknowledgeability of a particular NT-AE and a status of active or inactive.

A configurator of the present invention populates a filter that filters NT-AE notifications for conversion to OPC-AE notifications. The configurator comprises a configuration device that provides for entry into the filter of NT-AEs that are to be passed by the filter and configuration of the entered NT-AEs with one or more event characteristics selected from the group consisting of: event type, event source, event severity, event category, event condition, event sub-condition and event attributes.

According to one style of the configurator of the present invention, the event type comprises condition, simple and tracking.

According to another style of the configurator of the present invention, the event source comprises a name of a computer that created a particular NT-AE notification and an insertion string of the particular NT-AE thereof.

According to still another style of the configurator of the present invention, the event severity comprises predefined severity values or logged severity values.

### BRIEF DESCRIPTION OF THE DRAWINGS

Other and further objects, advantages and features of the present invention will be understood by reference to the following specification in conjunction with the accompanying drawings, in which like reference characters denote like elements of structure and:

FIG. 1 is a block diagram of a system that includes the event filtration and notification device of the present invention;

FIG. 2 is a block diagram that shows the communication paths among various runtime system management components of the event filtration and notification device according to the present invention;

FIG. 3 is a block diagram that shows the communication links among different computing nodes used by the event filtration and notification devices of the present invention;

FIG. 4 is a block diagram depicting a system event to OPC event transformation;

FIG. 5 is a block diagram depicting system event server interfaces; and

FIGS. 6-10 are selection boxes of a filter configuration tool of the present invention.

### DESCRIPTION OF THE PREFERRED EMBODIMENT

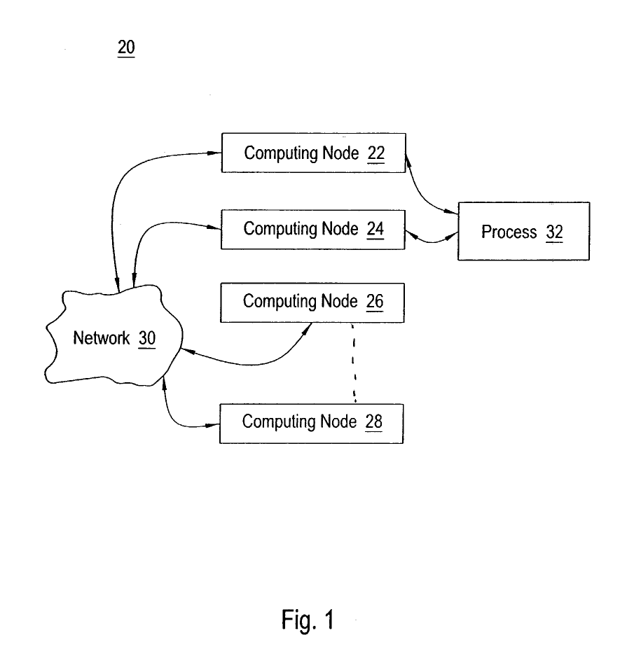

Referring to FIG. 1, a system 20 includes a plurality of computing nodes 22, 24, 26 and 28 that are interconnected via a network 30. Network 30 may be any suitable wired, wireless and/or optical network and may include the Internet, an Intranet, the public telephone network, a local and/or a wide area network and/or other communication networks. Although four computing nodes are shown, the dashed line between computing nodes 26 and 28 indicates that more or less computing nodes can be used.

System 20 may be configured for any application that keeps track of events that occur within computing nodes or are acknowledged by one or more of the computing nodes. By way of example and completeness of description, system 20 will be described herein for the control of a process 32. To this end, computing nodes 22 and 24 are disposed to control, monitor and/or manage process 32. Computing nodes 22 and 24 are shown with connections to process 32. These connections can be to a bus to which various sensors and/or control devices are connected. For example, the local bus for one or more of the computing nodes 22 and 24 could be a Fieldbus Foundation (FF) local area network. Computing nodes 26 and 28 have no direct connection to process 32 and may be used for management of the computing nodes, observation and other purposes.

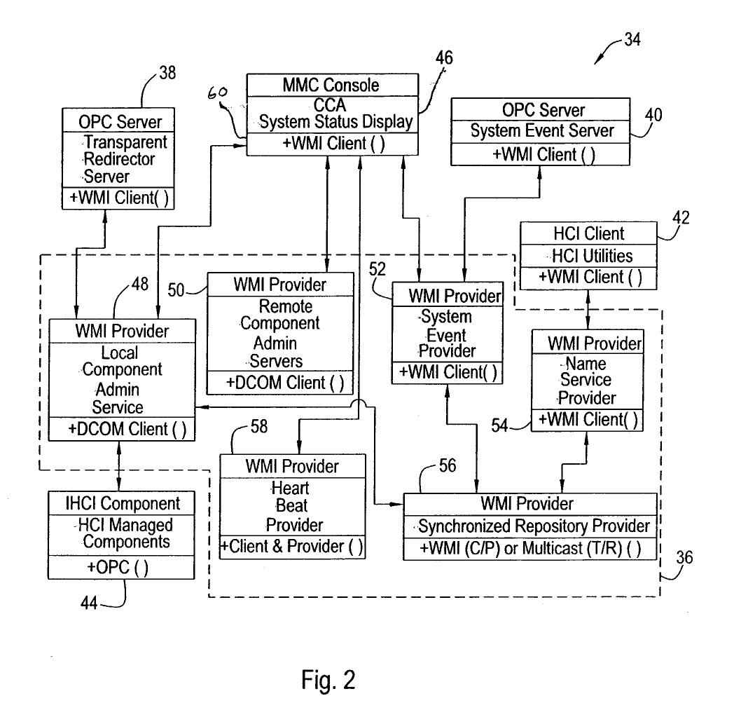

Referring to FIG. 2, computing nodes 22, 24, 26 and 28 each include a node computer 34 of the present invention. Node computer 34 includes a plurality of run time system components, namely, a WMI service 36, a redirector server 38, a System Event Server (SES) 40, an HCI client utilities manager 42, a component manager 44 and a system status display 46. WMI service 36 includes a local Component Administrative Service (CAS) provider 48, a remote CAS provider 50, a System Event Provider (SEP) 52, a Name Service Provider (NSP) 54, a Synchronized Repository Provider (SRP) 56 and a heart beat provider 58. The lines in FIG. 2 represent communication paths between the various runtime system management components.

SRP 56 is operable to synchronize the data of repositories in its computing node with the data of repositories located in other computing nodes of system 20.

For example, each of the synchronized providers of a computing node, such as SEP 52 and NSP 54, both of which have an associated data repository and are clients of SRP 56.

System status display 46 serves as a tool that allows users to configure and monitor computing nodes 22, 24, 26 or 28 and their managed components, such as sensors and/or transducers that monitor and control process 32. System status display 46 provides the ability to perform remote TPS node and component configuration. System status display 46 receives node and system status from its local heart beat provider 58 and SEP 52. System status display 46 connects to local component administrative service provider 48 of each monitored node to receive managed component status.

NSP 54 provides an alias name and a subset of associated component information to WMI clients. The NSP 54 of a computing node initializes an associated database from that of another established NSP 54 (if one exists) of a different computing node and then keeps its associated database synchronized using the SRP 56 of its computing node.

SEP 52 publishes local events as system events and maintains a synchronized local copy of system events within a predefined scope. SEP 52 exposes the system events to WMI clients. As shown in FIG. 2, both system status display 46 and SES 40 are clients to SEP 52.

Component manager 44 monitors and manages local managed components. Component manager 44 implements WMI provider interfaces that expose managed component status to standard WMI clients.

Heart beat provider 58 provides connected WMI clients with a list of all the computing nodes currently reporting a heart beat and event notification of the addition or removal of a computing node within a multicast scope of heart beat provider 58.

SRP 56 performs the lower-level inter-node communications necessary to keep information synchronized. SEP 52 and NSP 54 are built based upon the capabilities of SRP 56. This allows SEP 52 and NSP 54 to maintain a synchronized database of system events and alias names, respectively.

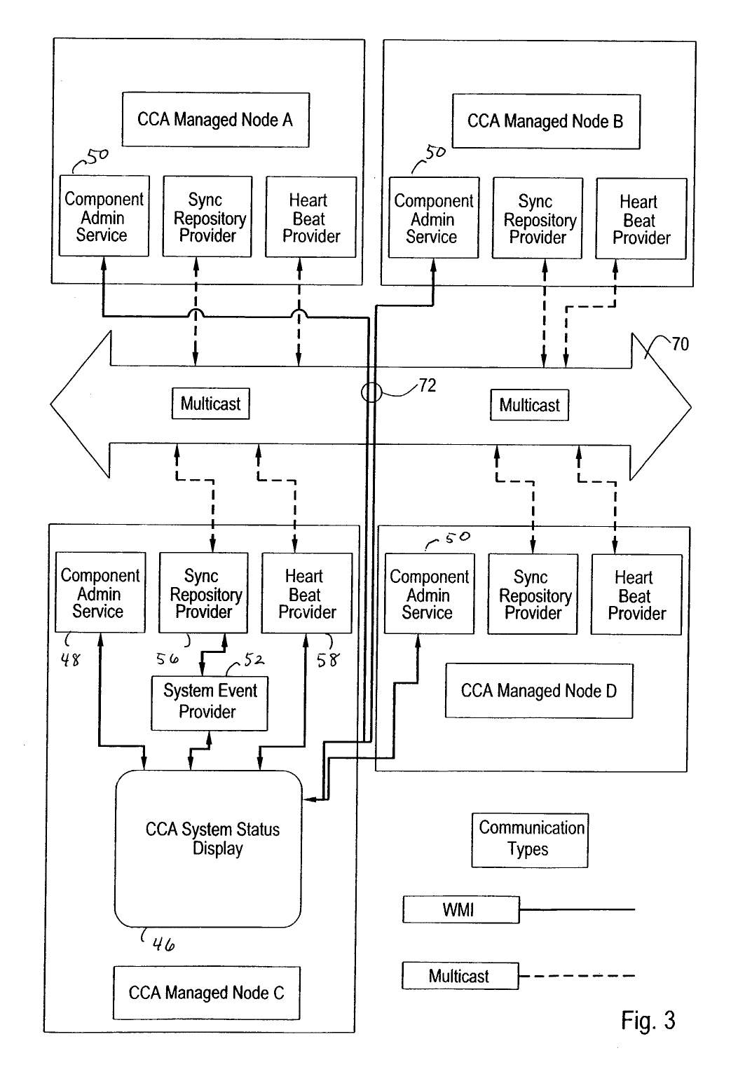

Referring to FIG. 3, SRP 56 and heart beat provider 58 use a multicast link 70 for inter-node communication. System status display 46, on the other hand, uses the WMI service to communicate with its local heart beat provider 58 and SEP 52. System status display 46 also uses the WMI service to communicate with local CAS provider 48 and remote CAS provider 50 on the local and remote managed nodes.

System status display 46 provides a common framework through which vendors deliver integrated system management tools. Tightly coupled to system status display 46 is the WMI service. Through WMI, vendors expose scriptable interfaces for the management and monitoring of system components. Together system status display 46 and WMI provide a common user interface and information database that is customizable and extendible. A system status feature 60 is implemented as an MMC Snap-in that provides a hierarchical view of computer and managed component status. System status feature 60 uses an Active Directory Service Interface (ADSI) to read the configured domain/organizational unit topology that defines a TPS Domain. WMI providers on each node computer provide access to configuration and status information. Status information is updated through WMI event notifications.

A system display window is divided into three parts:

Menu/Header—common and customized controls displayed at the top of the window are used to control window or item behavior.

Scopepane—left pane of the console window is used to display a tree-view of installed snap-ins and their contained items.

Resultpane—the right pane of the console window displays information about the item selected in the scopepane. View modes include Large Icons, Small Icons, List, and Detail (the default view). Managed components may also provide Custom Active X controls for display in the resultpane.

System Event Provider

SEP 52 is a synchronized provider of augmented NT Log events. It uses filter table 84 to restrict the NT Log events that are processed and augments those events that are passed with data required to generate an OPC-AE-compliant event. It maintains a repository of these events that is synchronized, utilizing SRP 56, with every node within a configured Active Directory scope. SEP 52 is responsible for managing event delivery and state according to the event type and attributes defined in the event filter files.

SEP 52 is implemented as a WMI provider. WMI provides a common interface for event notifications, repository maintenance and access, and method exportation. No custom proxies are required and the interface is scriptable. SEP 52 utilizes SRP 56 to synchronize the contents of its repository with all nodes within a configured Active Directory Scope. This reduces network bandwidth consumption and reduces connection management and synchronization issues.

The multicast group address and port, as well as the Active Directory Scope, are configured from a Synchronized Repository standard configuration page. Like all other standard configuration pages, this option will be displayed in a Computer Configuration context menu by system status display 46.

A default SEP 52 client configuration will be written to an SRP client configuration registry key. The key will contain the name and scope values. The name is the user-friendly name for the SEP service and scope will default to “TPSDomain”, indicating the containing active directory object (TPS Domain Organizational Unit).

Not all NT events are sent to the system event subscribers. Filter tables are used to determine if an event is to pass through to clients, as well as to augment data for creating an OPC event from an NT event. Events that do not have entries in this table will be ignored. A configuration tool is used to create the filter tables.

OPC events require additional information that can be obtained in the NT events, such as Event Category, Event Source and if the event is acknowledgeable. The filter table preferably contains the additional information for the transformation of an NT event to an OPC event format. Event source is usually the combination of a computer name and a component name separated by a dot, but it can be configured to leave out the computer name. The computer name is the name of the computer that generates the event. The component name is one of the insertion strings of the event. It is usually the first insertion string, but is also configurable to be any one of the insertion strings.

Events are logged to the NT event log files using standard event logging methods (Win32 or WMI). SEP 52 registers for _InstanceCreationEvent notification for new events. When notified, and if the event is to pass through, a provider-maintained summary record of the event is created and an _InstanceCreationEvent is multicast to the System Event multicast group.

SEP 52 reads the filter tables defined by System Event Filter Snap-in 86. The filter tables determine which events will be logged to the SEP repository and define the additional data required for generation of an OPC-AE event. The System Event Filter table 84 assigns a severity to each event type since Windows event severity does not necessarily translate directly to the desired OPC event severity. If a severity of 0 is specified, the event severity assigned to the original NT Event will be translated to a pre-assigned OPC severity value. The NT event to OPC event severity transformation values are set forth in Table 27.

Two main classes of events are handled by SEP 52: Condition Related events and Simple/Tracking events. Condition Related events are maintained in a synchronized repository within SEP 52 on all nodes within the configured scope. Simple or Tracking Events are delivered real-time to any connected clients. There is no guarantee of delivery, no repository state is maintained, and no event recovery is possible for simple or tracking events.

SEP 52 maintains a map of all condition-related events by source and condition name combination. As new condition-related events are generated, events logged with the same source and condition name will be inactivated automatically by posting a _InstanceModificationEvent with the Active=FALSE property.

Condition state changes generate a corresponding Tracking Event. SEP 52 generates an extrinsic event notification identifying the condition, state, timestamp, and user.

When performing synchronization, SEP 52 will update the active state of condition-related events in the synchronized view with the state maintained in the local event map. If the local map does not contain a condition event included in the synchronized view, the event will be inactivated in the repository.

Because condition events and their associated return-to-normal events (inactivating related active condition events) are loosely coupled, an event logging entity may not log the required return-to-normal event and the condition-related events in the active state might not be correctly inactivated. To ensure that these events can be cleared from the SES (GOPC_AE) condition database and the SEP repository, each acknowledged, active event will be run down for a configurable period (set to a default period during installation) and inactivated when the period expires.

Simple and tracking events are not retained in the SEP repository but are delivered as extrinsic events to any connected clients. These events are delivered through the SRP SendExtrinsicNotification( ) method to all SEPs. There is no recovery of simple or tracking events. These events are not acknowledgeable. If an event display chooses to display these events, acknowledgement or other means of clearing an event on one node will not affect other nodes.

A new WMI class will be added to support the extrinsic tracking and simple event types. The SEP will register this new class (TPS_SysEvt_Ext) with SRP 56. SRP 56 will discover that the class derives from the WMI _ExtrinsicEvent class and will not perform any synchronization of these events. SRP 56 will act in a pass-through mode only.

A map of condition-related events by source and condition name will be maintained by SEP 52. Each SEP 52 will manage the active state of the condition-related events being generated on the local node.

Condition events maintained in the SEP repository are replicated to all nodes within the SEP scope; therefore, during startup or resynchronization due to rejoining a broken synchronization group, all condition-related events would be recovered. Simple and tracking events are transitory, single-shot events and cannot be recovered.

The SEP TPS_SysEvt class implements the ACK( ) method. This method will be modified to add a comment parameter. The WMI class implemented by the SES, TPS_SysEvt will also be modified to add the AckComment string property, the AcknowledgeID string property, and a Boolean Active property. The new ModificationSource string property will be set by the SEP that is generating a _InstanceModificationEvent.

Events may be acknowledged on any node within the multicast group. The acknowledgement is multicast to all members of the System Event multicast group packaged in an _InstanceModificationEvent object. The SEP 52 on each node will log an informational message to its local CCA System Event Log, identifying the source of the acknowledgement.

Once an event has been acknowledged, it may be cleared from the system event list. This deletes the event from the internally maintained event list and generates an _InstanceDeletionEvent to be multicast to the System Event multicast group. An-informational message will be posted to the CCA System Event Log file identifying the source of the event clear request.

WMI Provider Object

The WMI provider object implements the “Initialize” method of the IWbemProviderInit interface, the CreateInstanceEnumAsync and the ExecMethodAsync methods of the IWbemServices interface, and the ProvideEvents method of the IWbemEventProvider interface. The Initialize method performs internal initialization. The CreateInstanceEnumAsync method creates an instance for every entry in the internal event list and sends it to the client via the IWbemObjectSink interface. Two methods are accessible through the ExecMethodAsync method: AckEvent and ClearEvent. They update the internal event list and call the SRP Client Object to notify external nodes. The ProvideEvents method saves the IwbemObjectSink interface of the client to be used when an event occurs. Three callback methods, CreateInstanceEvent, ModifyInstanceEvent and DeleteInstanceEvent, are implemented to notify its clients via the saved IWbemObjectSink interface. The CreateInstanceEvent method is called by the NT Event Provider object when an event is created locally and by the SRP Client object when an event is created remotely. The ModifyInstanceEvent method and the DeleteInstanceEvent methods are called by the SRP Client object when an event is acknowledged or deleted remotely.

During server startup, this subsystem reads the directory paths to filter tables from a multi-string register key. It loads the filter tables and creates a local map in the memory. At runtime, it provides methods called by NT Event Log WMI Client to determine if events are to be passed to subscribers and provide additional OPC specific data.

NT Event Client Object

During server startup, this subsystem registers with the NT Event Log Provider and requests for notifications when events are logged to the NT event log files. When Instance Creation notifications are received, this subsystem calls the event filtering subsystem and constructs an event with additional data. It then calls the SRP Client object to send notifications to external nodes.

SRP Client Object

During server startup, the SRP Client Object registers with SRP 56. If data synchronization is needed immediately, it will receive a SyncWithSource message. Periodically it will also receive the SyncWithSource message if SRP 56 determines that the internal event list is out of data synchronization. When a SyncWithSource message is received, it uses the “Source” property of the message to connect to the SEP 52 on the external node and requests the event list. The internal event list is then replaced with the new list. If an event is created on a remote node, an InstanceCreation message will be received. It will add the new event to the internal event list and ask the WMI Provider object to send out notifications to clients. The scenario applies when events are modified (acknowledged) or cleared. When events are logged locally, the NT Event client object will call this object to send an Instance Creation message to external nodes. When events are acknowledged or cleared by a client, the WMI provider object will call this subsystem to send an Instance Modification or Deletion message to external nodes. If a LostMsgError or DuplicateMsgError message is received, no actions are taken.

SES 40 is a WMI client of SEP 52. Each event posted by SEP 52 is received as an InstanceCreationEvent by SES 40. Tracking events are one-time events and are simply passed up by SES 40. Condition events reflect the state of a specific monitored source. These conditions are maintained in an alarm and event condition database internal to SES 40. SEP 52 populates received NT Events with required SES information as retrieved from the filter table. This information includes an event cookie, a source string, event severity, event category and type, as well as whether an event is ACKable and the current ACKed state.

As new condition-related events are received for a given source, the new condition must supercede the previous condition. Upon receipt of a condition-related event, SEP 52 will look up the current condition of the source and will generate an _InstanceModificationEvent, inactivating the current condition. The new condition event is then applied.

Synchronized Repository Provider

SRP 56 is the base component of SEP 52 and NSP 54. SEP 52 and NSP 54 provide a composite view of a registered instance class. SEP 52 and NSP 54 obtain their respective repository data through a connectionless, reliable protocol implemented by SRP 56.

SRP 56 is a WMI-extrinsic event provider that implements a reliable Internet Protocol (IP) multicast-based technique for maintaining synchronized WBEM repositories of distributed management data. SRP 56 eliminates the need for a dynamic instance provider or instance client to make multiple remote connections to gather a composite view of distributed data. SRP 56 maintains the state of the synchronized view to guarantee delivery of data change events. A connectionless protocol (UDP) is used, which minimizes the effect of network/computer outages on the connected clients and servers. Use of IP multicast reduces the impact on network bandwidth and simplifies configuration.

SRP 56 implements standard WMI extrinsic event and method provider interfaces. All method calls are made to SRP 56 from the Synchronized Provider (e.g., SEP 52 or NSP 54) using the IWbemServices::ExecMethod[Async]( ) method. Registration for extrinsic event data from SRP 56 is through a call to the SRP implementation of IWbemServices::ExecNotificationQuery[Async]( ). SRP 56 provides extrinsic event notifications and connection status updates to SEP 52 and NSP 54 through callbacks to the client implementation of IWbemObjectSink::Indicate( ) and IWbemObjectSink::SetStatus( ), respectively. Since only standard WMI interfaces are used, (installed on all Win2K computers) no custom libraries or proxy files are required to implement or install SRP 56.

To reduce configuration complexity and optimize versatility, a single IP multicast address is used for all registered clients (Synchronized Providers). Received multicasts are filtered by WBEM class and source computer Active Directory path and then delivered to the appropriate Synchronized Provider. Each client registers with SRP 56 by WBEM class. Each registered class has an Active Directory scope that is individually configurable.

SRP 56 uses IP Multicast to pass both synchronization control messages and repository updates, reducing notification delivery overhead and preserving network bandwidth. Repository synchronization occurs across a Transmission Control Protocol/Internet Protocol (TCP/IP) stream connection between the synchronizing nodes. Use of TCP/IP streams for synchronization reduces the complexity multicast traffic interpretation and ensures reliable point-to-point delivery of repository data.

Synchronized Providers differ from standard instance providers in the way that instance notifications are delivered to clients. Instead of delivering instance notifications directly to the IWbemObjectSink of the winmgmt service, Synchronized Providers make a connection to SRP 56 and deliver instance notifications using the SRP SendInstanceNotification( ) method. The SRP then sends the instance notification via multicast to all providers in the configured synchronization group. Instance notifications received by SRP 56 are forwarded to the Synchronized Provider via extrinsic event through the winmgmt service. The Synchronized Provider receives the SRP extrinsic event, extracts the instance event from the extrinsic event, applies it to internal databases as needed, and then forwards the event to connected clients through winmgmt.

Synchronized data is delivered to the Synchronized Provider through an extrinsic event object containing an array of instances. The array of objects is delivered to the synchronizing node through a TCP/IP stream from a remote synchronized provider that is currently in-sync. The Synchronized Provider SRP client must merge this received array with locally-generated instances and notify remote Synchronized Providers of the difference by sending instance notifications via SRP 56. Each Synchronized Provider must determine how best to merge synchronization data with the local repository data.

Client applications access synchronized providers (providers which have registered as clients of the SRP) as they would for any other WBEM instance provider. The synchronized nature of the repository is transparent to clients of the Synchronized Provider.

SRP 56 will be configured with an MMC property page that adjusts registry settings for a specified group of computers. SRP configuration requires configuration of both IP Multicast and Active Directory Scope strings.

By default, SRP 56 will utilize the configured IP Multicast (IPMC) address for heartbeat provider 58 found in the HKLM\Software\Honeywell\FTE registry key. This provides positive indications as to the health of the IP Multicast group through LAN diagnostic messages (heartbeats). The UDP receive port for an SRP message is unique (not shared with the heartbeat provider 58). Multicast communication is often restricted by routers. If a site requires synchronization of data across a router, network configuration steps may be necessary to allow multicast messages to pass through the router.

Active Directory Scope is configured per Synchronized Provider (e.g., SEP 52 or NSP 54). Each installed Client will add a key with the name of the supported WMI Class to the HKLM\Software\Honeywell\SysMgmt\SRP\Clients key. To this key, the client will add a Name and Scope value. The Name value will be a REG_SZ value containing a user-friendly name to display in the configuration interface. The Scope value will be a REG_MULTI_SZ value containing the Active Directory Scope string(s).

The SRP configuration page will present the user with a combo box allowing selection of an installed SRP client to configure. This combo box will be populated with the name values for each client class listed under the SRP\Clients key. Once a client provider has been selected, an Active Directory Tree is displayed with checkbox items allowing the user to select the scope for updates. It will be initialized with check marks to match the current client Scope value.

To pass instance contents via IP Multicast, the IWbemClassObject properties must be read and marshaled via a UDP IP Multicast packet to the multicast group and reconstituted on the receiving end. Each notification object is examined and the contents written to a stream object in SRP memory. The number of instance properties are first written to the stream, followed by all instance properties, written in name (BSTR)/data (VARIANT) pairs. The stream is then packaged in an IP Multicast UDP data packet and transmitted. When received, the number of properties is extracted and the name/data pairs are read from the stream. A class instance is created and populated with the received values and then sent via extrinsic event to the winmgmt service for delivery to registered clients (Synchronized Providers). Variants cannot contain reference data. Variants containing safe arrays of values will be marshaled by first writing the variant type, followed by the number of instances contained in the safe array, and then the variant type and data for all contained elements.

To avoid response storms, multicast responses are delayed randomly up to a requestor-specified maximum time before being sent. If a valid response is received by a responding node from another node before the local response is sent, the send will be cancelled.

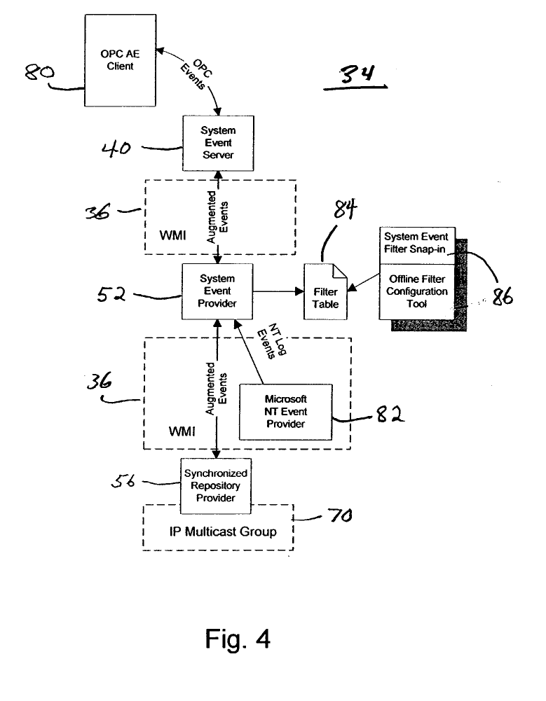

Referring to FIG. 4, node computer 34 is shown in a configuration that depicts filtration of NT-AE notifications and notification of OPC-AEs according to the present invention. Notifications of OPC-AEs are received by SRP 56 from other computing nodes in system 20 via multicast link 70. SRP 56 passes these notifications to SEP 52, using WMI service 36, provided that SEP 52 is a subscriber to a group entitled to receive the notifications. SEP 52 in turn passes the OPC-AE notifications via WMI service 36 to SES 40. SES 40 in turn passes the OPC-AE notifications to its subscriber clients, such as OPC-AE client 80. OPC-AE notifications generated by OPC-AE client 80 (or other OPC clients of SES 40) are received by SES 40 and passed to SRP 56 via WMI service 36 and SEP 52. SRP 56 then packages these OPC-AE notifications for distribution to the appropriate subscriber groups, distribution being via SEP 40 for local clients thereof and via multicast link 70 for remote clients of other computing nodes.

WMI service 36 includes an NT event provider 82 that contains notifications of NT-AEs occurring within node computer 34. NT event provider 82 uses WMI service 36 to provide these NT-AE notifications to SEP 52. As noted above, not all NT-AEs are sent to OPC clients as NT events are in an NT format and not an OPC format. In accordance with the present invention, a filter table 84 is provided to filter the NT-AE notifications and transform them into OPC-AE notifications.

A filter configuration tool, System Event Filter Snap-in 86, is provided to allow a user to define those NT-AE notifications that will be transformed to OPC-AE notifications and provided to subscriber clients. The aforementioned additional information necessary to transform an NT-AE notification to an OPC-AE notification is also provided for use by SEP 52 and, preferably, is contained within filter table 84. The additional information includes such items as event type (simple, tracking and conditional), event category, event source, event severity (1-1000) and a source insertion string, as well as whether the event is acknowledgeable.

When selected by a user, System Event Filter Snap-in 86 displays all registered message tables on node computer 34. Upon selection of the message table that is used to log the desired event, all contained messages are displayed in the resultpane and additional values from the pre-existing filter table file are updated. If no file exists, a new file for the desired event is created. The user also selects the message to be logged by SEP 52 and enters the additional information required for translating an NT-AE notification into an OPC-AE notification. Upon completion, the updated filter table is saved.

Logical Design Scenarios for a First Embodiment

CAS 48 provides the following services depending on server type. The following is a list of servers supported:

HCI Managed server

HCI Managed Status server

Non-Managed Transparent Redirector server

Non-Managed OPC server

CAS 48 provides the following services for HCI Managed servers:

Automatic detection and monitoring of configured servers.

Optionally auto-start the server at node startup.

Expose methods for WMI clients to initiate server startup, shutdown, and checkpoint.

Expose the monitored server status information to WMI clients.

CAS 48 provides the following services for Non-Managed servers:

Expose methods for WMI clients to start and stop monitoring of Non-Managed servers.

Expose the monitored server status information to WMI clients.

Since changes to component configuration and reported component state affect the control process, CAS 48 logs events to the Windows Application Event Log that are picked up by the SEP 52 for delivery to the SES 40. SES 40 converts the Windows OR NT-AE notification into an OPC-AE notification that may be delivered through an OPC-AE interface.

The following scenarios describe the event logging requirements for CAS 48 and the subsequent processing performed by the SEP 52 and SES 40.

The scenario set forth in Table 1 shows a WMI client making a component method call. The usage of the Shutdown method call is merely to illustrate the steps performed when a client calls a method on an HCI component. Other component method calls follow a similar procedure.

The node is started and CAS 48 is started and the HCI component is running.

TABLE 1

| Event | Description of Event |
|---|---|
| 1 | A System Status Display user right clicks the appropriate compo- |
| | nent and selects the Stop menu item |
| 2 | CAS 48 receives the request and initiates the shutdown method on |
| | the HCI component. |
| 3 | The HCI component performs the shutdown operation. |
| 4 | CAS 48 detects the state change and creates a component modifica- |
| | tion event that notifies all connected WMI clients of the status |
| | change. |
| 5 | The CAS 48 records the state change to the application event log. |
| 6 | SEP 52 detects the new event log entry and adds a condition event |
| | to SRP 56 in an unacknowledged state. |

A new HCI Managed component is added to the node. CAS 48 automatically detects the new component. The node is started and CAS 48 is started and a new HCI Managed component was added using an HCI component configuration page as shown in Table 2.

TABLE 2

| Event | Description of Event |
|---|---|
| 1 | CAS 48 receives an update from Windows 2000, indicating the |
| | registry key containing component information has been modified. |
| 2 | CAS 48 detects a new HCI Managed component and starts a moni- |
| | tor thread. |
| | A managed component must have the IsManaged value set to Yes/ |
| | True or it will be ignored. For example, the TRS will be set to No/ |
| | False. |
| 3 | CAS 48 creates a component Creation Event that notifies all con- |
| | nected WMI clients of the new component. |
| 4 | The monitor thread waits for component startup to start monitoring |
| | status. |
| 5 | An entry is written to the local Application event log that indi- |
| | cates a new component was created. |
| 6 | SEP 40 detects the event and adds it to the System Event repository |
| | as a tracking event. |

The configuration of an HCI Managed component is deleted. CAS 48 automatically detects the deleted component. The node is started and CAS 48 is started. The component was stopped and a user deletes a Managed component using the HCI component configuration page as shown in Table 3.

TABLE 3

| Event | Description of Event | |
|---|---|---|
| 1 | CAS 48 receives an update from Windows 2000, indicating the | |
| | registry key containing component information has been modified. | |
| 2 | CAS 48 detects the removal of the HCI component via modified | |
| | registry key. | |
| 3 | CAS 48 creates a component Deletion Event that notifies WMI | |
| | connected clients that the component was deleted. | |
| 4 | CAS 48 stops the thread monitoring the component. | |
| 5 | CAS 48 writes an event to the Application Event log for the com- | |
| | ponent being deleted, indicating the component is now in an un- | |
| | known state. | |
| 6 | SEP 52 detects the new event log entry and adds a condition event | |
| | to the System Event Repository. This event, which is assigned an | |
| | OPC server status of “Unknown”, is used by SES 40 to: | |
| | 1) | AutoAck any outstanding events with the same source as the |
| | | deleted component |
| | 2) | Conditions with the same source as the deleted component are |
| | | returned to normal. |

| | |
|---|---|
| 7 | An entry is written to the local Application event log (Event #2) |
| | that indicates a component was deleted. |
| 8 | SEP 52 detects the event and adds it to the System event repository |
| | as a tracking event. |

An HCI managed component changes state. The state change is detected by CAS 48 and exposed to connected WMI clients. The node is started, CAS 48 is started, and HCI Component A is running as shown in Table 4.

TABLE 4

| Event | Description of Event |
|---|---|
| 1 | The managed component A changes state (e.g., LCNP fails with |
| | TPN server; this causes state to change to warning). |
| 2 | CAS 48 detects component status change and exposes the informa- |
| | tion via WMI component modification event. |
| 3 | All connected WMI clients, such as the system status display 46, |
| | receive a WMI event indicating a state change |
| 4 | The component state change is written to the Application Event |
| | Log. |
| 5 | SEP 52 detects the new event log entry and adds a condition event |
| | to the System Event Repository in an unacknowledged state. |

An HCI managed Status component detects a status change of the monitored device. The status change is detected by CAS 48 and exposed to connected WMI clients. The node is started and GAS 48 is started and HCI Status Component A is running as shown in Table 5.

TABLE 5

| Event | Description of Event |
|---|---|
| 1 | The status component A is running and the monitored device re- |
| | ports a failure status (e.g., HB provider reports a link failure). |
| 2 | CAS 48 detects device status change and exposes the information |
| | via WMI component modification event to connected clients. |
| | Status components report both a component status and a device |
| | status. |
| | In this case only the state of the device is changing, and the |
| | component state is unchanged. |
| 3 | All connected WMI clients, such as system status display 46, |
| | receive a WMI event indicating a status change. |
| 4 | The device status change is written to the Application Event Log. |
| | These events will not be added to the filter table for System events. |
| | This is done to prevent duplicate events from multiple Computers. |
| 5 | SEP 52 detects the new event log entry and adds a condition event |
| | to the System Event Repository in an unacknowledged state. |

The Transparent Redirector Server (TRS) a Non-Managed component requests CAS 48 to monitor its status. The node is started and CAS 48 is started and TRS is starting up as shown in Table 6.

TABLE 6

| Event | Description of Event |
|---|---|
| 1 | TRS connects to local CAS 48 via WMI and calls the monitor |
| | component method with its own name and IUnKnown pointer. |
| 2 | CAS 48 makes the component name unique and creates a thread to |
| | monitor the component. |
| | The reason for the unique name is that there may be multiple |
| | instances of the same name/component. |
| | The unique name is component's name. |
| | The unique name must also continue after reboots and TRS shut- |
| | downs to ensure that a new TRS instance does not obtain the same |
| | name as in an earlier instance, which was stopped. This would |
| | create confusion when reconciling existing events. |
| 3 | CAS 48 returns the unique component name back to TRS through |
| | the method call. |
| | The unique name is used when requesting stop monitoring of the |
| | component. |
| 4 | CAS 48 creates a component Creation Event to notify WMI con- |
| | nected clients of the newly monitored component. |
| 5 | CAS 48 writes an entry into the Application Event Log, indicating |
| | the component is being monitored. |
| 6 | SEP 52 detects the new event log entry and adds a tracking event |
| | to the System Event Repository. |

The Transparent Redirector Server (TRS) requests CAS 48 to stop monitoring its status. The node is started and the CAS 48 is started and a monitored TRS is shutting down, as shown in Table 7.

TABLE 7

| Event | Description of Event |
|---|---|
| 1 | TRS connects to local CAS 48 via WMI and calls the Unmonitor |
| | component method with the unique name returned by the monitor |
| | component method. |
| 2 | CAS 48 stops the components monitor thread. |
| 3 | CAS 48 writes an event to the Application Event log for the |
| | component being deleted, indicating the component is now in an |
| | unknown state. |
| 4 | SEP 52 detects the new event log entry and adds a condition event |
| | to the System Event Repository. This event is used by SES 40 to |
| | inactivate OPC A&E event in the condition database. |
| 5 | CAS 48 creates a component Deletion Event to notify WMI con- |
| | nected clients that the component is no longer being monitored. |
| 6 | CAS 48 writes an entry into the Application Event Log indicating |
| | the component is no longer being monitored. |
| 7 | SEP 52 detects the new event log entry and adds a tracking event |
| | the System Event Repository. |

Heartbeat provider 58 periodically multicasts a heartbeat message to indicate the node's health. The node is started and heartbeat provider 58 starts as shown in Table 8.

TABLE 8

| Event | Description of Event |
|---|---|
| 1 | Heartbeat provider 58 starts multicasting IsAlive messages. |
| 2 | Other heartbeat providers 58 monitoring the same multicast address |
| | receive the IsAlive multicast message and add the node to the list |
| | of alive nodes. |
| 3 | WMI clients are alerted to the new node when a WMI instance |
| | creation event occurs on their local WMI heartbeat providers. |

The node fails or is shut down as depicted in Table 9.

TABLE 9

| Event | Description of Event |
|---|---|
| 1 | The node fails and stops sending IsAlive heartbeat messages. |
| 2 | Other heartbeat providers 58 monitoring the multicast address |
| | detect the loss in communication to the failed node. |
| 3 | The heartbeat providers 58 reflect the failed status of the node by |
| | deleting the reference to the node. |
| 4 | WMI clients are alerted to the failure via a WMI deletion instance. |
| 5 | Heart beat provider 58 logs an event to the Application Event Log. |
| 6 | SEP 52 detects the event checks filter table and conditionally logs |
| | event to the Synchronized repository. |

Note: SES nodes will be the only nodes with filters for heartbeat provider 58. This prevents multiple copies of node failure events.

SEP 52 is a synchronized repository of NT-AEs. The NT-AEs may have been generated by the system, CCA applications, or third party applications. It utilizes the SRP 56 to maintain a consistent view of system events on all nodes. It also utilizes filter table 84 to control NT-AE notifications that become OPC-AE notifications.

Filter table 84 provides an inclusion list of the events, which will be added to SRP 56. Any Window 2000 event can be incorporated. All events are customized to identify information such as event type (Simple, Tracking, Conditional), severity (1-1000), and Source insertion string index, etc., that are needed for SES 40, as depicted in Table 10.

TABLE 10

| Event | Description of Event |
|---|---|
| 1 | The user starts the SEP Filter Snap-in 86. Snap-in 86 displays all |
| | registered message tables on the computer. |
| 2 | The user selects the message table that is used to log the desired |
| | event. Snap-in 86 displays all contained messages in the result- |
| | pane and updates additional values from the pre-existing filter |
| | table file. If no file exists, it is created when the changes are saved. |
| 3 | The user selects the message that should be logged by the |
| | SEP 52 and enters the additional information required for trans- |
| | lating the event into an OPC event. |
| 4 | The user saves the filter table 84. |
| 5 | Filter table 84 is distributed to all computers (manually or through |
| | Win2K offline folder) that need to log the event. |
| 6 | The user stops and restarts SEP 52 service. |

The HCI Name Service builds and maintains a database of HCI/OPC server alias names. Client applications use the name service to find the CLSID, ProgID, and name of the node hosting the server. Access to the Name Service is integrated into the HCI toolkit APIs like GetComponentInfo( ) to provide backward compatibility with previously developed HCI client applications.

The synchronized database of alias names is maintained on all managed nodes. Each node is assigned to a multicast group that determines the synchronized database scope. The node is started and the Windows Service Control Manager (SCM) starts the HCI Name Service. The node is properly configured and assigned to a multicast group. Other nodes in the group are already operational as depicted in Table 11.

TABLE 11

| Event | Description of Event | |
|---|---|---|
| 1 | Name Service registers with SRP 56. | |
| 2 | Name Service sends a request to SRP 56 to request for synchroni- | |
| | zation source. | |
| 3 | SRP 56 on a remote node responds to the request. | |
| 4 | Name Service synchronizes with responding node by making a | |
| | WMI connection to the remote name service provider. The Name | |
| | Service enumerates all instances of the source node's name | |
| | service and initializes the local repository with the exception of | |
| | Host's file entries. | |
| 5 | Name Service compares the nodes TPSDomain association in the | |
| | active directory to what was recorded the last time the node | |
| | started. If no active directory is available, the last recorded | |
| | TPSDomain will be used. | |
| | If the TPSDomain was recorded and a change is detected, skip to | |
| | the scenario that describes what happens when a node is moved to | |
| | another TPSDomain. | |
| | The TPSDomain is included in the Active directory distinguished | |
| | name of the node. The distinguished name of the node is recorded | |
| | in the registry in UNC format. | |
| 6 | Name Service queries local registry for locally-registered compo- | |
| | nents and checks for duplication of names. | |
| | 1. | If NOT found, the component is added to the Synchronized |
| | | Name Service Repository. |
| | 2. | If found and all the information is the same, no further action |
| | | is required. |
| | 3. | If found and the server is Local Only, it replaces the duplicate |
| | | entry and does not synchronize. |
| | 4. | If found and it is a domain component, a duplication compo- |
| | | nent alias event is written to the application log. This dupli- |
| | | cated event is configured into the system event filter table 84, |
| | | so it will be shown in the system status display 46. |
| 7 | Name Service reads HCI Host's file and checks for duplication of | |
| | names. | |
| | 1. | If NOT found, the component is added to the Local Name |
| | | Service Repository. |
| | 2. | If found and all the information is the same, no further action |
| | | is required. |
| | 3. | If found and information not same, a duplication component |
| | | alias event is written to the application log. This duplicated |
| | | event is configured into the system event filter table 84, |
| | | so it will be shown in the system status display 46. |

The following scenarios do not provide detail on OPC client connections to SES 40. Instead, the scenarios attempt to provide background on the WMI-to-SES 40 interaction.

SES 40 subscribes to SEP 52 instance creation and modification events. SEP 52 is a synchronized repository utilizing SRP 56 to keep its synchronized repository of system events in synchronization with all computers within a specified Active Directory scope. SES 40 is responsible for submitting SEP events to the GOPC-AE object for distribution to OPC clients as depicted in Table 12.

TABLE 12

| Event | Description of Event |
|---|---|
| 1 | SES 40 starts and performs all required initialization, including |
| | creation of the GOPC-AE object containing the condition database. |
| 2 | SES 40 connects via the winmgmt (WMI) server to SEP 52. |
| 3 | SES 40 registers for instance creation and modification events. |
| 4 | SES 40 enumerates all existing event instances and updates the |
| | condition database via the OPC AE interface. |

SES 40 subscribes to SEP 52 instance creation and modification events. SEP 52 is a synchronized repository utilizing SRP 56 to keep its synchronized repository of system events in synchronization with all computers within a specified Active Directory scope. This scope is defined by a registry setting with a UNC format Active Directory path. A path to the TPS Domain would indicate that all computers with the TPS Domain Organizational Unit (OU) would be synchronized. A path to the Domain level would synchronize all SEPs within the Domain, regardless of TPS Domain OU. This setting is configured via a configuration page that can be launched from system status display 46 or Local Configuration Utility. The user launches system status display 46. All computers should be on-line since registry configuration must be performed as depicted in Table 13.

TABLE 13

| Event | Description of Event |
|---|---|
| 1 | User right clicks the node that will host the SES HCI Component |
| | in system status display scope pane and selects the HCI Component |
| | Entry in the context menu. |
| 2 | The HCI Component Configuration Page is displayed. |
| 3 | Select the Alias name of the Component. |
| 4 | Restore fields in the HCI Component Configuration Page. |
| 5 | The user modifies fields of the HCI component specific informa- |
| | tion (checkpoint file location, OPC method access security proxy |
| | files). |
| 6 | The user invokes the DSS specific configuration page and modifies |
| | the multicast scope field. Top-level synchronization will apply the |
| | “*” path as the scope, resulting in synchronization of all nodes |
| | within the IP Multicast group. |
| 7 | The user selects Apply. |
| 8 | Data is written to the registry on the node, which hosts the com- |
| | ponent. Proxy files are automatically created on the node that will |
| | host the component. |

A second preferred embodiment will now be described for system 20 that utilizes the same node computer 34 as shown in FIGS. 2-4 with additional features.

Filter Configuration Tool

System Event Filter Snap-in 86 includes system status display 46 and an input device therefor, such as a keyboard and/or mouse (not shown), for user entry of NT-AEs and characteristics thereof that contain the additional information for converting an NT-AE notification to an OPC-AE notification. For example, the characteristics may comprise the event types (condition, simple or tracking), event source (identified by text and an NT event log insertion string), event severity (predefined values or logged values), event category (note exemplary values in Table 26), event condition (note exemplary values in Table 26), event sub-condition (based on event condition) and event attributes (as defined by event category). A user uses the System Event Filter Snap-in 86 to enter in filter table 84 the NT events for which notifications thereof are to be passed for conversion to OPC-AE notifications.

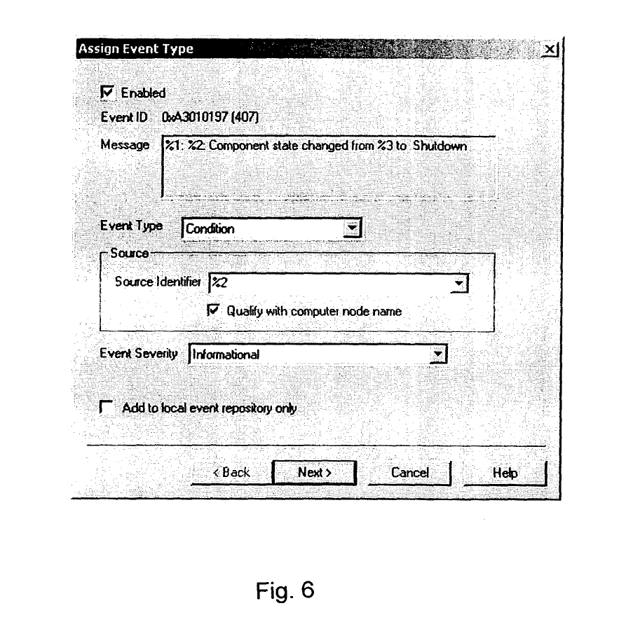

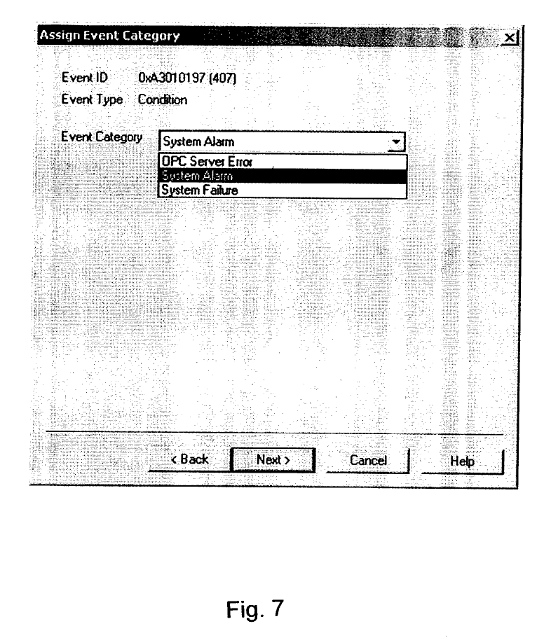

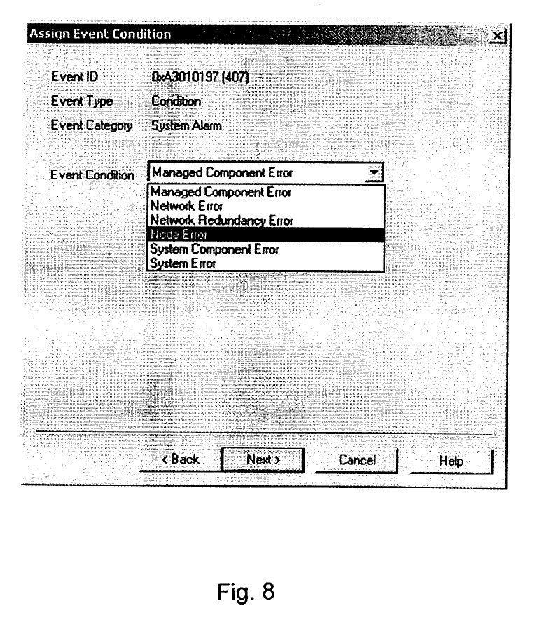

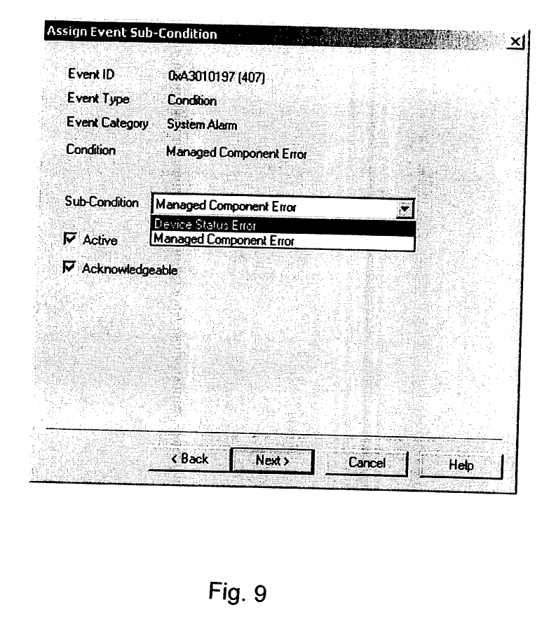

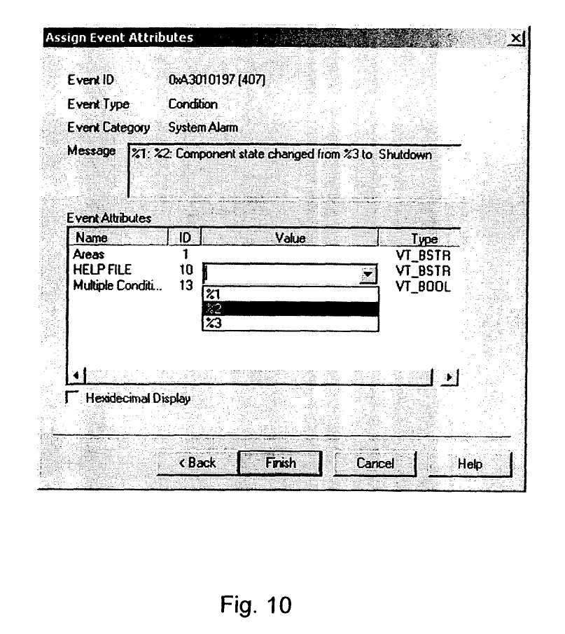

Referring to FIGS. 6-10, System Event Filter Snap-in 86 presents to the user on system status display 46 a series of selection boxes for the assignment of event type (FIG. 6), event category (FIG. 7), event condition (FIG. 8), event sub-condition (FIG. 9) and event attributes (FIG. 10).

Logical Design of System Event Server (SES)

Referring again to FIG. 4, SES 40 is an HCI-managed component that exposes NT-AE notifications as OPC-AE notifications. SES 40 exposes OPC-AE-compliant interfaces that can be used by any OPC-AE client to gather system events. SES 40 utilizes the SEP 52 to gather events from a predefined set of computers. SEP 52 receives NT-AE notifications that are logged and filters these notifications based on a filter file. NT-AE notifications that pass through the filter are augmented with additional qualities required to generate an OPC-AE notification. SEP 52 maintains a map of active Condition Related events and provides automatic inactivation of superceded condition events. SEP 52-generated events are passed to SES 40 for delivery as OPC-AE notifications. SES 40 is responsible for packaging the event data as an OPC-AE notification and for maintaining a local condition database used to track the state of condition-related OPC-AEs.

During startup, SEP 52 will scan all events logged since node startup or last SEP 52 shutdown to initialize the local condition database to include valid condition states. SEP 52 will then start processing change notifications from the Microsoft Windows NTEventLog provider.

Event Augmentation

System Event Filter Snap-in 86 is used to define additional data required to augment the NT Log Event information when creating an OPC-AE notification. System Event Filter Snap-in 86 will configure the OPC-AE type, whether the event is ACKable, and if the item is condition related, the condition is assigned to the event. If an event is defined as a condition-related event type, the event may be a single-shot event (INACTIVE) or a condition that expects a corresponding return-to-normal event (ACTIVE). Events identified as ACTIVE must have an associated event defined to inactivate the condition.

An OPC-AE severity is assigned to each event type since Windows event severity does not necessarily translate directly to the desired OPC-AE severity. The System Event Filter Snap-in 86 will be used to assign an OPC -AE severity value. If a severity of zero (0) is specified, the event severity assigned to the original NT-AE will be translated to a pre-assigned OPC-AE severity value. The SES does not utilize sub-conditions. Condition sub-conditions will be a duplicate of the condition name.

Event Maintenance

SES 40 subscribes to SEP 52-generated events. SEP 52 is responsible for maintaining the state of condition-related events that are synchronized across all nodes by SRP 56. All condition-related events and changes to their state, including acknowledgements, are global across all SEPs contained within a configured Active Directory Scope. All new conditions and changes to existing conditions will generate OPCConditionEventNotifications. The contained ChangeMask will reflect the values for the conditions that have changed. SEP 52 will generate tracking events when conditions are acknowledged.

New condition-related events are received by SES 40 from SEP 52 as WMI_InstanceCreationEvents. Acknowledgements and changes in active state are reflected in WMI_InstanceModificationEvents. When a condition is both acknowledged and cleared, a WMI_InstanceDeletionEvent will be delivered. Simple and tracking events are delivered as WMI_ExtrinsicEvents and are not contained in any repository.

There is no synchronization (beyond multicast delivery to all listening nodes) and no state maintained for simple and tracking events. These events will be received only by clients connected at the time of their delivery. The SEP TPS_SysEvt class is used to maintain condition-related events. The TPS_SysEvt_Ext class is used to deliver simple and tracking events.

Event Recovery

All condition events are maintained in the SEP 52 repository. The SEP 52 repository is synchronized across all nodes within its configured scope. Any node that loses its network connection or crashes will refresh its view with one of the synchronized views when the condition is corrected. Condition events are maintained by the node that sources the event. Condition events identified during synchronization as being sourced from the local node that do not match the current local state, will be inactivated by SEP 52.

Simple and tracking events are not synchronized and are not recoverable. Condition state maintenance is performed by the logging node. State is then synchronized with all other nodes. Loss of any combination of nodes will not impact the validity of the event view.

Condition timestamps are based on condition activation time and will not change due to a recovery refresh.

Browsing

SES 40 supports hierarchical browsing. Areas are defined by the Active Directory objects contained within the configured SEP 52 scope. Hierarchical area syntax is in the reverse order of Active Directory naming convention and must be transposed. The area name format will be:

\\RootArea\Area1\Area2

where RootArea, Area1, and Area2 are Active Directory Domain or Organization Unit objects and Area2 is contained by Area1, and Area1 is contained by RootArea.

SES 40 will walk the Active Directory tree starting at the Active Directory level defined within the scope of SEP 52. An internal representation of this structure will be maintained to support browsing and for detection of changes in the Active Directory configuration. SES 40 sources are typically the computers and components within the areas defined in the Active Directory scope of SEP 52. Events sourced from a computer, but having no specific entity to report will use the name of the logging computer as the source. Events regarding specific entities residing on the computer will use the source name format COMPUTER.COMPONENT (e.g., COMPUTER1.PKS_SERVER_{—}01). Contained computers will be added as sources to each area. Other sources (e.g., Managed Components with the source name convention Source.Component) will be added dynamically as active events are received.

Enable/Disable

Enabling or disabling events on one SES will not affect other SESs, whether they are in the same or different scopes. If a Redirection Manager (RDM) is used, the RDM will enable or disable areas and sources on the redundant SES connections, maintaining a synchronized view. Enable/Disable is global for all clients connected to the same SES.

SES Subsystems

SES 40 utilizes the HCI Runtime to provide OPC-compatible Alarm and Event (AE) interfaces. HCI Runtime and GOPC_AE objects perform all OPC client communication and condition database maintenance. Device Specific Server functionality is implemented in the SES Device Specific Object (DSSObject). This object will create a single instance of an event management object that will retrieve events from SEP 52 and forward SEP 52 event notifications to GOPC_AE. In addition, a single object will maintain a view of the Active Directory configuration used to define server areas and the contained sources.

Databases in SES

The following lookup maps will be maintained:

TABLE 14
SES internal Maps

| | |
|---|---|
| Hierarchical area and source map | A hierarchical mapping of objects |
| | representing Active Directory con- |
| | tainers (Areas) and the contained |
| | event sources. This map will be used |
| | to return Areas in Area and Sources |
| | in Area. It will also be used when |
| | performing the periodic scan of the |
| | Active Directory to identify changes |
| | in the Active Directory hierarchy. |
| Map of OPC Event cookie to WMI | Used to look up WMI instance signa- |
| Event guide | ture when an OPC client acknowl- |
| | edges an event. |

The following performance counters are maintained for monitoring SES 40 operation.

TABLE 15
SES Performance Counters

| Counter | Type | Description |
|---|---|---|
| Connected Clients | RAWCOUNT | Number of current client connec- |
| | | tions (non-reserved DssObject |
| | | instances) |
| Events Logged | RAWCOUNT | Number of events processed since |
| | | server startup |
| Events Logged per | COUNTER | Number of events processed in the |
| second | | past second (derived from Events |
| | | Logged) |
| Condition Events | RAWCOUNT | Number of ACKable events |
| Logged | | processed since server startup. |
| Condition Events | COUNTER | Number of ACKable events |
| Logged per second | | processed in the past second |
| | | (derived from ACKable Events |
| | | Logged) |
| Simple Events | RAWCOUNT | Number of simple events received |
| Logged | | |
| Simple Events | COUNTER | Number of Simple events proc- |
| Logged per second | | essed in the past second (de- |
| | | rived from Simple Events Logged) |
| Tracking Events | RAWCOUNT | Number of tracking events re- |
| Logged | | ceived |
| Tracking Events | COUNTER | Number of Tracking events |
| Logged per second | | processed in the past second |
| | | (derived from Tracking Events |
| | | Logged) |

Interfaces in System Event Server (SES)

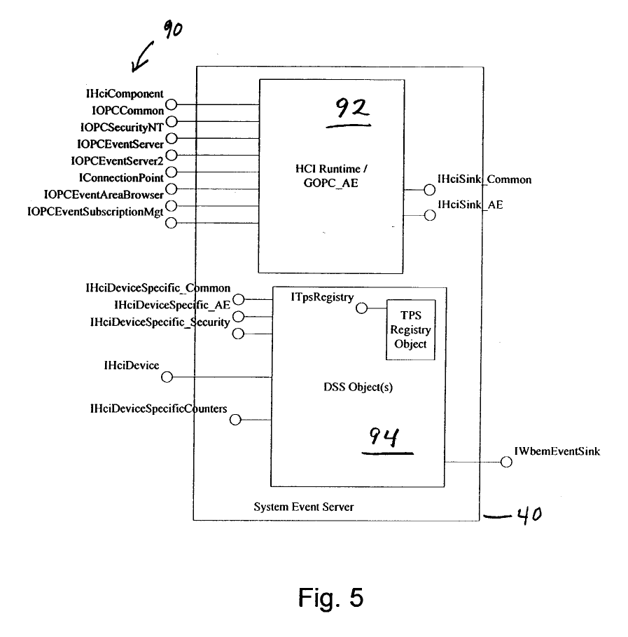

Referring to FIG. 5, SES 40 exposes a plurality of interfaces 90 to OPC-AE client 80. Interfaces 90 are implemented by the HCI Runtime components 92. Internally, SES 40 implements a device-specific server object, shown as DSS Object 94 that communicates with HCI Runtime components 92 through standard HCI Runtime-defined interfaces. DSS Object 94 provides all server-specific implementation.

The System Event Server DSS object implements the IHciDeviceSpecific_Common, IHciDeviceSpecific_AE, IHciDeviceSpecific_Security, IHciDeviceSpecificCounters and IHciDevice interfaces.

The HCI Runtime IHciSink_Common interface is used to notify clients (via HCI Runtime) of area and source availability changes.

The IHciSink_AE GOPC_AE interface is used to notify clients of new and modified events. A periodic (4 sec) heartbeat notification is sent on this interface to validate the GOPC_AE/SES connection state. When the DSS connections are not valid (lost heartbeats or access errors), SES 40 logs an event (identified in the filter table as a DEVCOMMERROR condition), identifying the DSS communication error, and reflects the problem in status retrieved by CAS 48 through IHciDevice::GetDeviceStatus( ). The heartbeats on the GOPC_AE IHciSink_AE interface will be halted, thereby identifying a loss of communication to the GOPC_AE object. When the connection is restored, SES 40 logs another event (identified in filter table 84 as an inactive DEVCOMMERROR condition) and updates the device state. The heartbeats will be restored to GOPC_AE, which will trigger a call by GOPC_AE to the SES DSS Object Refresh( ) method. The SES DSS Object will in turn enumerate all instances from the restored SEP connection and will post each instance to the GOPC_AE sink interface with the bRefresh flag set. SES DSS object 94 implements the optional IHciDevice interface that exposes the GetDeviceStatus( ) method to the Component Admin Service (CAS). SES 40 implements this interface to reflect the status of the event notification connections. A failed device status will be returned to indicate that the SEP connection has not been established or is currently disconnected. Likewise, SEP 52 will reflect errors in its connection to the SRP up to the SES 40 through error notifications. The device information field returned by GetDeviceStatus( ) will contain a string that describes the underlying connection problem.

SES DSS object 94 also implements the IHciDeviceSpecificCounters interface to support the DSS performance counters.

Server event logging is performed using the HsiEventLog API. HCI Component configuration values for SES 40 will be retrieved using the ITpsRegistry interface.

Logical Design Scenarios for Second Embodiment

A managed component changes state to the FAILED state. A condition event must be generated to the OPC client, as depicted in Table 16.

TABLE 16
Condition Event is Generated - New Active Alarm

| Event | Description of Event |
|---|---|
| 1 | Managed Component goes into the FAILED state. |
| 2 | CAS 48 detects the state change and logs a Window event. |
| 3 | The SEP 52 service is notified of the event and examines its filter |
| | tables. |
| 4 | The component state change event is identified in the filter tables |
| | as an Active Condition Related Event. |
| 5 | A TPS_SysEvt class instance is created and the filter table in- |
| | formation is set in the event object. |
| 6 | SEP 52 checks its map of source-to-condition events for a condi- |
| | tion event that is currently active; none is found. |
| 7 | SEP 52 creates an _InstanceCreationEvent and inserts the |
| | TPS_SysEvt instance. It passes the _InstanceCreationEvent to |
| | SRP 56. |
| 8 | SRP 56 distributes (multicasts) the _InstanceCreationEvent to all |
| | SEPs 52. |
| 9 | All SEPs receive the event and notify connected clients of the re- |
| | ceived event. |
| 10 | SES 40 receives the event notification. |
| 11 | The event information is converted to an OPC-AE event notifi- |
| | cation and is sent to the subscribed OPC-AE client(s). |

A managed component has previously entered the WARNING state. This generated an active condition alarm. The component now transitions to the FAILED state, generating a new active condition. The previous condition is no longer active, as depicted in Table 17.

TABLE 17
Condition Event is Generated - Active Alarm Exists

| Event | Description of Event |
|---|---|
| 1 | Managed Component transitions into the FAILED state from the |
| | WARNING state. |
| 2 | CAS 48 detects the state change and logs a Window event. |
| 3 | SEP 52 service is notified of the event and examines its filter ta- |
| | bles. |
| 4 | The component state change event is identified in the filter tables |
| | as an Active Condition Related event. |
| 5 | A TPS_SysEvt class object is created and the filter table infor- |
| | mation is set. (EventB) |
| 6 | SEP 52 checks its map of source to condition events for a condition |
| | event that is currently active; the WARNING condition alarm is |
| | found. (EventA) |
| 7 | (EventA) The TPS_SysEvt object containing the WARNING |
| | condition alarm (found in step 6) is set to INACTIVE. |
| 8 | (EventA) SEP 52 creates a _InstanceModificationEvent and |
| | inserts the inactivated WARNING condition event TPS_SysEvt |
| | object. |
| 9 | (EventA) SEP 52 issues the modification event to SRP 56, which |
| | distributes the event to all SEPs. |
| 10 | (EventA) All SEPs 52 receive the event and notify connected |
| | clients (SES) of the received event. |
| 11 | (EventA) SES 40 receives the inactivated WARNING condition |
| | event notification. |
| 12 | (EventA) The inactivated event information is converted to an |
| | OPC-AE event notification and is sent to the subscribed OPC |
| | Client(s) |
| 13 | (EventB) SEP 52 creates an _InstanceCreationEvent and inserts |
| | the new FAILED condition event TPS_SysEvt object. |
| 14 | (EventB) SEP 52 issues the _InstanceCreationEvent to SRP 56, |
| | which distributes the event to all SEPs 52. |
| 15 | (EventB) All SEPs 52 receive the event and notify connected |
| | clients (SES) of the received event. |
| 16 | (EventB) SES 40 receives the inactivated WARNING condition |
| | event notification. |
| 17 | (EventB) The event information is converted to an OPC-AE event |
| | notification and is sent to the subscribed OPC Client(s) |

A failed managed component (an active event exists) is restarted and eventually transitions into the IDLE state, which is identified in the System Event Filter table as a return-to-normal condition, as depicted in Table 18.

TABLE 18
Condition Event is Generated
Return to Normal on Unacknowledged Event

| Event | Description of Event |
|---|---|
| 1 | Managed Component transitions into the IDLE state. |
| 2 | CAS 48 detects the state change and logs a Window event. |
| 3 | SEP 52 service is notified of the event and examines its filter |
| | tables. |
| 4 | The component state change event is identified in the filter tables |
| | as an Inactive, Unacknowledgeable Condition Related event. |
| 5 | SEP 52 checks its map of source to condition events for a condition |
| | event that is currently active; the FAILED condition alarm is |
| | found. |
| 6 | The TPS_SysEvt object containing the FAILED condition |
| | alarm (found in step 5) is set to INACTIVE. |
| 7 | SEP 52 creates a _InstanceModificationEvent and inserts the |
| | inactivated FAILED condition event TPS_SysEvt object. |
| 8 | SEP 52 issues the modification event to SRP 56, which distributes |
| | the event to all SEPs 52. |
| 9 | All SEPs 52 receive the event and notify connected clients (SES) |
| | of the received event. |
| 10 | SES 40 receives the inactivated WARNING condition event notifi- |
| | cation. |
| 11 | The inactivated event information is converted to an OPC-AE |
| | event notification and is sent to the subscribed OPC Client(s) |

Events can be acknowledged from below system status display 46 or another SES (via SEP) or from above through HCI Runtime interfaces. In this scenario, the acknowledgement is coming up through SEP 52. Operation is the same regardless of whether the acknowledgement is coming from another SES node or the System Management Display.

TABLE 19
Condition Event is Acknowledged from the SEP - Event is Active

| Event | Description of Event |
|---|---|
| 1 | User ACKs an event from the system status display 46. System |
| | status display 46 invokes the ACK method on SEP 52. |
| 2 | SEP 52 looks up the referenced TPS_SysEvt object in its reposi- |
| | tory and sets the ACKed property to TRUE. The |
| | ModificationSource property is set to the local computer name. |
| 3 | SEP 52 generates a _InstanceModificationEvent for the referenced |
| | event object and inserts the modified TPS_SysEvt object. |
| 4 | SEP 52 logs an NT event that will be interpreted as a tracking |
| | event to track the condition acknowledgement. |
| 5 | SEP 52 issues the event to SRP 56, which distributes the event to |
| | all SEPs 52. |
| 6 | All SEPs 52 receive the event and notify connected clients of the |
| | received event. |
| 7 | SES 40 receives the event modification notification. |
| 8 | The acknowledged event information is converted to an OPC-AE |
| | event notification and is sent to the subscribed OPC Client(s) |

An OPC client acknowledges an active condition event, as depicted in Table 20.

TABLE 20
Condition Event is Acknowledged from OPC Client - Event is Active

| Event | Description of Event |
|---|---|
| 1 | User Acknowledges an event from an OPC client. |
| 2 | SES 40 looks up the WMI event signature by cookie. |
| 3 | SES 40 invokes the SEP ACK() method for the event signature |
| | that was retrieved in step 2. |
| 4 | SEP 52 modifies the specified event ACK and ModificationSource |
| | properties. |
| 5 | SEP 52 generates a _InstanceModificationEvent populates it |
| | with the modified TPS_SysEvt and sends it to SRP 56. |
| 6 | SRP 56 sends the modification event to all SEPs 52. |
| 7 | SEP 52 receives the change notification, updates the local reposi- |
| | tory and forwards the change to SES 40. |
| 8 | SES 40 receives the change notification. |
| 9 | Since the ACK state was already modified, there is no change and |
| | no event is generated to the OPC Client(s). |

NOTE: Looking from a redundant SES perspective, the ACK state is different and a condition change is generated to the OPC Client(s) on the redundant server and any clients connected to the redundant server.

An inactive condition event is acknowledged through the SEP WMI interface (e.g., system status display 46). The inactive, acknowledged event is removed from the event repository as depicted in Table 21.

TABLE 21
Condition Event is Acknowledged from the SEP - Event is Inactive

| Event | Description of Event |
|---|---|
| 1 | User ACKs an event from the system status display 46. System |
| | status display 46 invokes the ACK method on SEP 52. |
| 2 | SEP 52 looks up the referenced TPS_SysEvt object and notes that |
| | the event is inactive. The ACKed property is set to TRUE. The |
| | ModificationSource property is set to the local computer name. |
| 3 | Since the event is now both inactive and acknowledged, SEP 52 |
| | generates a _InstanceDeletionEvent and inserts the modified |
| | TPS_SysEvt object. |
| 4 | SEP 52 logs an NT event that will be interpreted as a tracking |
| | event to track the condition acknowledgement. |
| 5 | SEP 52 issues the event to SRP 56, which distributes the event to |
| | all SEPs 52. |
| 6 | All SEPs 52 receive the event and notify connected clients (SES) |
| | of the received event. The TPS_SysEvt object is removed from |
| | the SEP event repository. |
| 7 | SES 40 receives the event deletion notification. |
| 8 | The acknowledged event information is converted to an OPC-AE |
| | event notification and is sent to the subscribed OPC Client(s) |

An OPC client acknowledges an inactive condition event. The inactive, acknowledged event is removed from the event repository as depicted in Table 22.

TABLE 22
Condition Event is Acknowledged from OPC Client
Event is Inactive

| Event | Description of Event |
|---|---|
| 1 | User Acknowledges an event from an OPC client. |
| 2 | SES 40 looks up the WMI event signature by cookie. |
| 3 | SES 40 invokes the SEP ACK() method using the event signature |
| | retrieved above. |
| 4 | SEP 52 looks up the referenced TPS_SysEvt object and notes that |
| | the event is inactive. The ACKed property is set to TRUE. The |
| | ModificationSource property is set to the local computer name. |
| 5 | Since the event is now both inactive and acknowledged, SEP 52 |
| | generates a _InstanceDeletionEvent and inserts the modified |
| | TPS_SysEvt object. |
| 6 | SEP 52 logs an NT event that will be interpreted as a tracking |
| | event to track the condition acknowledgement. |
| 7 | SEP 52 issues the event to SRP 56, which distributes the event to |
| | all SEPs 52. |
| 8 | All SEPs 52 receive the event and notify connected clients (SES) |
| | of the received event. The SEP(s) 52 remove the TPS_SysEvt |
| | object from their repositories. |
| 9 | SES 40 receives the event deletion notification. |
| 10 | Since the condition was already deleted, no event is generated to |
| | the OPC Client(s). |

NOTE: Looking from a redundant SES perspective, the ACK state is different and a condition change is generated to the OPC Client(s) on the redundant server and any clients connected to the redundant server.

A FAILED managed component is restarted and eventually transitions into the IDLE state, which is identified in the System Event Filter table as a return-to-normal condition event as depicted in Table 23.

TABLE 23
Condition Event is Generated
Return to Normal on Acknowledged Event

| Event | Description of Event |
|---|---|
| 1 | Managed Component transitions into the IDLE state. |
| 2 | CAS 48 detects the state change and logs a Window event. |
| 3 | SEP 52 service is notified of the event and examines its filter |
| | tables. |
| 4 | The component state change event is identified in the filter tables |
| | as an Inactive, Unacknowledgeable Condition Related event (return |
| | to normal). |
| 5 | SEP 52 checks its map of source-to-condition events for a condi- |
| | tion event that is currently active; the FAILED condition alarm is |
| | found. |
| 6 | The TPS_SysEvt object containing the FAILED condition alarm is |
| | set to INACTIVE. |
| 7 | Since the event is now both inactive and acknowledged, SEP 52 |
| | generates a _InstanceDeletionEvent and inserts the modified |
| | TPS_SysEvt object. |
| 8 | SEP 52 logs an NT event that will be interpreted as a tracking |
| | event to track the condition acknowledgement. |
| 9 | SEP 52 issues the event to SRP 56, which distributes the event to |
| | all SEPs 52. |
| 10 | All SEPs 52 receive the event and notify connected clients (SES) |
| | of the received event. The SEP(s) remove the TPS_SysEvt object |
| | from their repositories. |
| 11 | SES 40 receives the event deletion notification. |
| 12 | The acknowledged event information is converted to an OPC-AE |
| | event notification and is sent to the subscribed OPC Client(s). |

An OPC client creates an instance of the SES and subscribes to event notifications as depicted in Table 24.

TABLE 24
OPC Client Subscribes for SES Events

| Event | Description of Event |
|---|---|
| 1 | OPC Client creates an out-of-process instance of SES 40. |
| 2 | SES 40 server object is created and the interface is marshaled to |
| | out-of-process client. |
| 3 | The OPC Client creates an inprocess IOPCEventSink object. |
| 4 | The OPC client gets an IConnectionPointContainer interface |
| | from a call to IOPCEventServer::CreateEventSubscription(). |
| 5 | The OPC client calls Advise() on the IconnectionPointContiner |
| | interface of SES 40 passing the IUnknown pointer of the client |
| | IOPCEventSink object. |
| 6 | The OPC client QIs for the IOPCEventSubscriptionMgt2 interface |
| | on the interface returned from CreateEventSubscription(). |
| 7 | The OPC client calls IOPCEventSubscriptionMgt2::SetKeepAlive() |
| | to set the keep-alive interval of heartbeats on the callback interface. |
| 8 | SES 40 sends new events to the client using the |
| | IOPCEventSink::OnEvent() method. If no event has been generated |
| | when the keep-alive is about to expire, a keep-alive will be gener- |
| | ated. |

An OPC client creates an instance of SES 40 and subscribes to event notifications. The callback connection is lost as depicted in Table 25.

TABLE 25
OPC Client Loses Connection to SES

| Event | Description of Event |
|---|---|
| 1 | OPC Client subscribes to SES events as in Table 27, OPC Client |
| | Subscribes for SES Events. |
| 2 | A network or other communication anomaly breaks the callback |
| | connection to the connected OPC client. |
| 3 | No event is received by the OPC client before the specific keep- |
| | alive period has expired. |
| 4 | The OPC client Unadvise()s the connection point (in case the |
| | problem is strictly a callback issue). |
| 5 | If the Unadvise succeeds, the client may choose to resubscribe for |
| | events. |
| 6 | If the Unadvise fails, the client should release his SES refer- |
| | ence and perform the complete reconnection scenario again. |

NOTE: In most cases this is the preferred action for ANY callback problem. Releasing and reinstantiating a new instance of the SES will ensure that DCOM flushes the old interfaces from its cache.

Robustness and Safety

The HCI Runtime implements a heartbeat on the OPC-AE callback. Clients use this heartbeat to verify that the callback connection is operational. SES 40 supports redundant operation using Redirection Manager (RDM). SES 40 itself is unaware that it is operating in a redundant configuration. It is the user's responsibility to configure RDM to access redundant SES 40 servers and to ensure that the configuration is compatible between the two instances of SES 40. When one SES server, or the node it is running on, fails, the failover time is as documented for RDM. Since the actual state of the event repository is maintained in the synchronized SEP 52 repository on all nodes, the SES view from Direct Stations will be the same.

Connection to the System Event Provider through WMI is maintained by the common module InstClnt.dll. Notification of loss of connection, reconnection attempts, and notification of restored connection are handled by the threads implemented within the InstClnt.dll. Should the server fail for any reason, it will automatically restart when any client attempts to reference it.

System Event Filter Snap-in

The System Event Filter Snap-in 86 tool is a Microsoft Management Console snap-in that provides the mechanism for defining the additional event properties associated with an OPC Alarm and Event. The System Event Filter Snap-in 86 provides a mechanism for selecting a Windows NT Event catalog file as registered in the Windows Registry. Event sources are selected from the list of sources associated with the message catalog and a list of events contained in the catalog is displayed. Configuration of a Windows NT Event as an OPC event is performed through a configuration “wizard”.

OPC-AE attributes are assigned by the configuration wizard, which conform to the following Table 26 Event Types, Categories and Condition Names.

TABLE 26
Event Types, Categories and Condition Names

| Event | Event Category/ | | |
|---|---|---|---|
| Type | Category ID | Condition Name | Description |
| Condition | | | Condition-related events are |
| Related | | | Acknowledgeable events that |
| | | | may be assigned the Active |
| | | | state. If the Active state is |
| | | | assigned to an event, another |
| | | | event that is logged when the |
| | | | source returns to normal |
| | | | must be identified. |
| | System Alarm/ | SYSERROR | ACKable, INACTIVE System |
| | 0x3003 | | error not isolatable to a |
| | | | specific component, node, or |
| | | | network. Source is the name |
| | | | of the node originating the |
| | | | condition. |
| | | NODEERROR | ACKable, INACTIVE |
| | | | Computer platform (node) |
| | | | error. Source is node name. |
| | | NETERROR | ACKable, ACTIVE/INACTIVE |
| | | | Network error. Source is |
| | | | “Network” or network |
| | | | (segment) name qualified by |
| | | | the name of the node |
| | | | originating the condition. |
| | | NETREDERROR | ACKable, ACTIVE/INACTIVE |
| | | | Problem with one link of a |
| | | | redundant pair. Source is the |
| | | | name of the link qualified by |
| | | | the name of the node |
| | | | originating the condition. |
| | | MANCOMPERROR | ACKable, ACTIVE Managed |
| | | | component error. Source is |
| | | | component name or alias |
| | | | qualified by node name. |
| | | | Insert String for Component |
| | | | name is mandatory. To |
| | | | inactivate, log an event |
| | | | identified with the same |
| | | | condition name but set to |
| | | | NOTACKable and INACTIVE |
| | | SYSCOMPERROR | ACKable, INACTIVE Generic |
| | | | system component error. |
| | | | Source is component name |
| | | | qualified by node name. |
| | | | Insert String for Component |
| | | | name is mandatory. |
| | | ANY VALID | NOT ACKable, INACTIVE No |
| | | CONDITON NAME | Error/Return-to-Normal |
| | | SET TO NOT | condition. This condition is |
| | | ACKABLE AND | not passed as an OPC event |
| | | INACTIVE | directly, but is used to |
| | | | change the named condition |
| | | | event to inactive. SEP |
| | | | searches the repository for an |
| | | | active condition with the |
| | | | same source and condition |
| | | | name. If found, the event is |
| | | | updated with inactive state. If |
| | | | no active condition is found, |
| | | | no OPC event is generated. |
| | OPC_SERVER_ERROR/ | DEVCOMMERROR | ACKable, ACTIVE The OPC |
| | 0x3004 | | Server is unable to |
| | | | communicate with its |
| | | | underlying device. Source is |
| | | | server name or alias qualified |
| | | | by node name. A |
| | | | corresponding |
| | | | communication-restored |
| | | | condition must also be |
| | | | specified. |
| Simple | | | NOT ACKable, INACTIVE |
| | | | Simple events are single-shot |
| | | | events that may be historized |
| | | | but are not displayed in the |
| | | | event viewer. |
| | Device Failure/ | | |
| | 0x1001 | | |
| | System | | |
| | Message/ | | |
| | 0x1003 | | |
| Tracking | | | NOT ACKable, INACTIVE |
| | | | Tracking events are single- |
| | | | shot events that are not |
| | | | retained in the system event |
| | | | repository. |
| | Process Change/ | | Modification of a process |
| | 0x2001 | | parameter by an interactive |
| | | | user or a control application |
| | | | program. This includes SEP |
| | | | logged condition tracking |
| | | | events |
| | System Change/ | | Modification of the system |
| | 0x2002 | | other than a configuration |
| | | | change, e.g., operator logon or |
| | | | logoff |
| | System | | Modification of the system |
| | Configuration/ | | configuration, e.g., adding a |
| | 0x2003 | | node to the TPS Domain |
| | | | (logged by SES when AD |
| | | | change is detected). |

An OPC event severity must be assigned to each event type since Windows or NT event severity does not necessarily translate directly to the desired OPC event severity. Table 27 presents the OPC Severity ranges and the equivalent CCA/TPS Priority (for reference purposes). If a severity of 0 is specified in the filter table, the event severity assigned to the original NT Event will be translated to a pre-assigned OPC Severity value.

TABLE 27
OPC Event Severity Translation

| | | Equivalent CCA/ |
|---|---|---|
| Severity Value Assigned | Translation | TPS Priority |
| 0 | Use the event severity | N/A |
| | assigned when the NT | |
| | Event was logged (be- | |
| | low) | |
| 200 (OPC range 1-400) | Success or Informational | Info (typically not |
| | | displayed but may |
| | | be journaled) |
| 500 (OPC range 401-600) | Warning | Low |
| 700 (OPC range 601-800) | Error | High |
| 900 (OPC range 801-1000) | | Urgent or Emer- |
| | | gency |

Databases in System Event Filter

The system event filters are stored in XML files in a Filters directory.

While we have shown and described several embodiments in accordance with our invention, it is to be clearly understood that the same are susceptible to numerous changes apparent to one skilled in the art. Therefore, we do not wish to be limited to the details shown and described but intend to show all changes and modifications, which come within the scope of the appended claims.

What is claimed is:

1. A method of notification of OPC alarms and events (OPC-AEs) and NT alarms and events (NT-AEs) to an OPC client comprising:
converting an NT-AE notification of an NT-AE to an OPC-AE notification; and
presenting said OPC-AE notification to said OPC client.

2. The method of claim 1, further comprising:
filtering said NT-AEs according to filter criteria.

3. The method of claim 2, wherein said filter criteria are provided by a filter configuration tool.

4. The method of claim 2, wherein said filter criteria are provided by a system event filter snap-in.

5. The method of claim 1, wherein said converting step adds additional information to said NT-AE notification to produce said OPC-AE notification.

6. The method of claim 5, wherein said additional information includes a designation of the source that created said NT-AE notification.

7. The method of claim 5, wherein said source designation comprises a name of a computer that created said NT-AE notification and an insertion string of said NT-AE.

8. The method of claim 7, wherein said insertion string identifies a component that generated said NT-AE.

9. The method of claim 5, wherein said additional information includes an event severity.

10. The method of claim 9, wherein said event severity is an NT compliant severity, wherein said converting step provides a transformation of said NT compliant severity to an OPC compliant severity.

11. The method of claim 10, wherein said transformation is based on pre-defined severity values.

12. The method of claim 11, wherein said transformation is based on logged severity values of said NT-AE notification.

13. The method of claim 5, wherein said additional information is one or more items selected from the group consisting of: event cookie, source designation, event severity, event category, event type, event acknowledgeability and event acknowledge state.

14. The method of claim 1, wherein said OPC client is either local or remote with respect to a source that created said NT-AE notification.

15. The method of claim 1, wherein said presenting step presents said OPC-AE notification to said OPC client via a multicast link.

16. The method of claim 1, wherein said NT-AEs comprise condition events, simple events or tracking events.

17. The method of claim 16, wherein at least one of said condition events reflects a state of a specific source.

18. The method of claim 1, further comprising synchronizing said OPC-AE notifications among a plurality of nodes via a multicast link.

19. The method of claim 1, wherein said OPC-AE notifications are accessible via OPC-AE interfaces or via WMI interfaces.

20. A device for notification of OPC alarms and events (OPC-AEs) and NT alarms and events (NT-AEs) to an OPC client, said device comprising:
a system event provider that links an NT-AE notification of an NT-AE to additional information; and
a system event server that packages said NT-AE notification and said additional information as an OPC-AE notification for presentation to said OPC client.

21. The device of claim 20, further comprising a filter that filters said NT-AE notifications according to filter criteria.

22. The device of claim 21, wherein said filter criteria are provided by a filter configuration tool.

23. The device of claim 21, wherein said filter criteria are provided by a system event filter snap-in.

24. The device of claim 20, wherein said additional information includes a designation of the source that created said NT-AE notification.

25. The device of claim 24, wherein said source designation comprises a name of a computer that created said NT-AE and an insertion string of said NT-AE, wherein said NT-AE is a condition event.

26. The device of claim 25, wherein said insertion string identifies a component that generated said NT-AE.

27. The device of claim 20, wherein said additional information includes an event severity.

28. The device of claim 27, wherein said event severity is an NT compliant severity, wherein said system event provider provides a transformation of said NT compliant severity to an OPC compliant severity.

29. The device of claim 28, wherein said transformation is based on pre-defined severity values.

30. The device of claim 28, wherein said transformation is based on logged severity values of said NT-AE notification.

31. The device of claim 20, wherein said additional information includes one or more items selected from the group consisting of: event cookie, source designation, event severity, event category, event type, event acknowledgeability and event acknowledge state.

32. The device of claim 20, wherein said OPC client is either local or remote with respect to a source that created said NT-AE notification.

33. The device of claim 20, further comprising a synchronized repository provider that presents said OPC-AE notification to said OPC client via a multicast link.

34. The device of claim 20, wherein said events are condition events, simple events or tracking events.

35. The device of claim 34, wherein at least one of said condition events reflects a state of a specific source.

36. The device of claim 20, further comprising a synchronized repository for synchronizing said OPC-AE notifications among a plurality of nodes via a multicast link.

37. The device of claim 20, wherein said OPC-AE notifications are accessible via OPC-AE interfaces or via WMI interfaces.

38. The device of claim 20, wherein said system event server serves said OPC-AE notifications to said OPC client.

39. The device of claim 20, wherein said system event provider communicates with said system event server via a WMI interface.

40. The device of claim 20, further comprising:
an NT event provider that provides said NT-AE notifications; and
a filter that filters said NT-AE notifications according to filter criteria so that only NT-AE notifications that satisfy said filter criteria are linked to OPC-AE notifications by said system event provider.

41. The device of claim 20, wherein one or more of said NT-AE notifications are condition events that are generated by a source and that reflect a state of said source, and further comprising changing a status between active and inactive of an earlier-occurring one of said condition events in response to a later-occurring one of said condition events generated due to a change in state of said source.

42. The device of claim 41, wherein said system event provider links the NT-AE notifications of said earlier- and later-occurring condition events to OPC-AE notifications for presentation to OPC clients.

43. The method of claim 1, wherein one or more of said NT-AEs are condition events that are generated by a source and that reflect a state of said source, and further comprising changing a status between active and inactive of an earlier-occurring one of said condition events in response to a later-occurring one of said condition events generated due to a change in state of said source.

44. The method of claim 43, wherein said converting and presenting steps convert NT-AE notifications of said earlier- and later-occurring condition events to OPC-AE notifications for presentation to OPC clients.

45. A method for populating a filter that filters NT alarms and events (NT-AEs) for conversion to OPC alarms and events comprising:
entering NT-AEs for which notifications thereof are to be passed by said filter; and
configuring said entered NT-AEs with one or more event characteristics selected from the group consisting of: event type, event source, event severity, event category, event condition, event sub-condition and event attributes.

46. The method of claim 45, wherein said event type comprises condition, simple and tracking.

47. The method of claim 45, wherein said event source comprises a name of a computer that created a particular NT-AE notification and an insertion string of the NT-AE thereof.

48. The method of claim 45, wherein said event severity comprises predefined severity values or logged severity values.

49. The method of claim 45, wherein said event category comprises a status of a device.

50. The method of claim 45, wherein said event attributes comprise for a particular event category, an acknowledgeability of a particular NT-AE and a status of active or inactive.

51. A configurator that populates a filter that filters NT alarms and events (NT-AEs) for conversion to OPC alarms and events comprising:
a configuration device that provides for entry into said filter of NT-AEs for which notifications thereof are to be passed by said filter and configuration of said entered NT-AEs with one or more event characteristics selected from the group consisting of: event type, event source, event severity, event category, event condition, event sub-condition and event attributes.

52. The configurator of claim 51, wherein said event type comprises condition, simple and tracking.

53. The configurator of claim 49, wherein said event source comprises a name of a computer that created a particular NT-AE notification and an insertion string of an NT-AE thereof.

54. The configurator of claim 49, wherein said event severity comprises predefined severity values or logged severity values.

55. The configurator of claim 49, wherein said event category comprises a status of a device.

56. The configurator of claim 49, wherein said event attributes comprise for a particular event category an acknowledgeability of a particular NT-AE and a status of active or inactive.
